(19) United States
(12) Patent Application Publication
(10) Pub. No.: US 2013/0037613 A1
(43) Pub. Date: Feb. 14, 2013

(54) APPARATUS, SYSTEM, AND METHOD TO STOCK PRODUCT AND MAINTAIN INVENTORY

(71) Applicant: David W. SOLDATE, Bentonville, AK (US)

(72) Inventor: David W. SOLDATE, Bentonville, AK (US)

(73) Assignee: WAL-MART STORES, INC., Bentonville, AK (US)

(21) Appl. No.: 13/208,965

(22) Filed: Aug. 12, 2011

(51) Int. Cl. G06Q 30/00

(52) U.S. Cl. 235/385

(57) ABSTRACT

An apparatus and system provides instructions to correctly stock a product, provides a next task upon completion of the stocking, and updates an inventory database based on completion of the stocking. A label on a product or set of products is scanned. The type of the label is determined and the product is identified. Based on the identification, a location is determined and provided through audio output. Confirmation of the stocking is received.

### FIELD OF THE INVENTION

The present invention relates generally to stocking product in a retail store or distribution center and to maintaining an accurate inventory. More particularly, the present invention relates to a system providing audio output with instructions regarding stocking and to a system maintaining inventory based on the stocking.

### BACKGROUND OF THE INVENTION

A distribution center receives a large number of shipments each day that must be cataloged and properly stored for redistribution to their ultimate destination. In a retail environment, incoming shipments must be stored and ultimately placed on store shelves in an organized manner to allow customers easy access to desired products. The products on the store shelves must be properly inventoried so that, for example, additional products are ordered, as needed, in a timely fashion.

The employee charged with the proper handling of an arriving package must identify the product, which is most often identified by a label on the package or an RFID, and determine the correct location for the product.

Depending on the experience level of the employee and his or her level of familiarity with the products and facilities, this shelving process can be inefficient and may be performed incorrectly.

An error in this process can lead to further inefficiency because of the time spent in trying to find misplaced products. Additionally, an inaccurate inventory of available products can lead to over-ordering of already available products and failure to replenish needed products.

### SUMMARY OF THE INVENTION

Thus, an apparatus and system is needed so that, when a product arrives at a distribution center or retail store, that product may be stocked in a way that makes retrieval of that product by a customer for purchase or by a storeroom employee for redistribution or stocking at a retail store easy and efficient. Further, it is desirable to treat the product stocking process as part of a workflow and manage tasks based on a confirmation that a given product was properly stocked.

Additionally, an inventory management system is needed to track not only product availability but also the location of products (e.g. on the retail store shelf, in a specific area within a distribution center).

The foregoing needs are met, to a great extent, by the present invention.

In accordance with one embodiment, a product locator is provided that comprises a reading device to read an identifier code of a product presented by a user; a code determination module including a processor to determine a type of the identifier code; a decoder to determine product information based on the type of the identifier code; a locator to determine a location of the product based on the product information; and an audio output device to provide an audio output of the location in which the product is to be placed.

In accordance with another embodiment of the present invention, a method of providing stocking instructions is provided, the method comprising receiving input of an identifier code associated with the product; determining, by a processor, a type of the identifier code; decoding, based on the type of the identifier code, product information of the product; determining, based on the product information, a location of the product; and providing, through audio output, the location of the product.

In accordance with yet another embodiment of the present invention, a system of managing product is provided, the system comprising a workflow manager configured to assign a task to stock the product, a product locator configured to provide a voice output of a location at which to stock the product, and an inventory processor configured to update an inventory database based on a confirmation that the product was stocked at the location.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a stocking, workflow management, and inventory system, according to an embodiment of the invention.

FIG. 2 is a flow chart of the stocking, workflow management, and inventory updating process, according to a preferred embodiment of the invention.

### DETAILED DESCRIPTION

The invention will now be described with reference to the drawing figures, in which like reference numerals refer to like parts throughout.

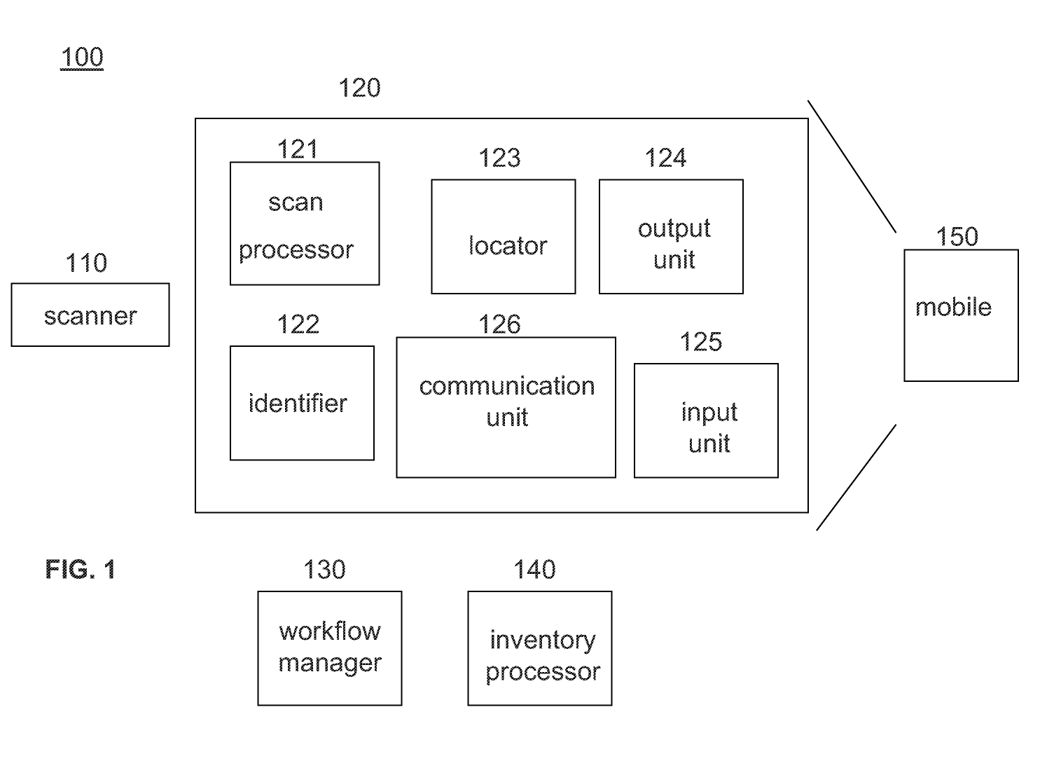

FIG. 1 is a block diagram of a product locator system 100 to provide instructions to stock a product, according to a non-limiting embodiment of the invention. As used herein, “product” can refer to one or multiple of an item. For example, a refrigerator is a “product” and one hundred pairs of jeans are also a “product” to be stocked and inventoried.

A scanner 110 is first used to scan a label associated with the item or package containing one or more items. The scanner may be, for example, a hand-held scanner that scans product codes. The scanner may also be, for example, an RFID scanner or interrogator.

The scanner 110 may be integrated with a product locator 120 or may be a separate unit in communication with the product locator 120 through a wireless communication protocol.

The product locator 120 includes a scan processor 121 that processes the scanned information. The scan processor 121 may be implemented by software instructions executed by a processor or by a special purpose processor, for example.

The scanned information is used by an identifier 122 to identify the type of code on the scanned label. The identifier 122 may be implemented by software executed by a general purpose processor, for example, or by a dedicated processor. Alternately, the identifier may include an existing, commercially available device separate from and coupled with or integrated into the product locator 120.

The types of codes can include, but are not limited to, a Universal Product Code (UPC) associated with, for example, a vendor or a product. The types of bar codes used could include, but are not limited to, GTIN-12 (UPC-A), GTIN-13 (EAN-13), GTIN-8, UCC-128, GTIN-14, Databar, and internal or Proprietary bar codes.

The identifier 122 additionally identifies the product based on the identified code. Then the locator 123 determines a location for the identified product. This location may be, for example, an aisle and bin within a retail facility or specific location within a distribution center. For example, the product locator 120 may be used to initially stock a load of product coming into a retail store on the store shelves. In another example, the product locator 120 may be used to re-stock a single item returned at the customer service desk of a retail store. The locator 123 may be implemented by a commercially available product such as Global Cross-Functional Locator.

Once the location of the product has been determined by the locator 123, an output unit 124 may generate an audio output to a user of the product locator system 100. The audio output from the output device 124 may provide location and also directions. The output device 124 may be a commercially available product such as Naturally Speaking, Vocollect Voice System, or Vox Voice System.

Once a user has stocked the product based on the location information provided by the output device 124, the user may provide confirmation that the stocking of the product is complete via an input device 125. The input device 125 may be, for example, a microphone such that the input is voice input.

Based on the input confirmation at the input device 125, a controller 126 and communication unit 127 may communicate with a workflow manager 130 and inventory processor 140, as detailed below, and provide workflow instructions to the user via the output device 124.

The functionality of the scan processor 121, identifier 122, locator 123, output device 124, input device 125, controller 126, and communication device 127 may be combined in various combinations into one or more software modules executed by a processor or hardware devices.

The communication device 127 may communicate with a server within the facility or outside the facility to receive updates of scan types, vendor and product codes, and locations, and upgrades of voice output technology.

A workflow manager 130 may be integrated with or separate from the product locator 120. A workflow manager 130 that is separate from the product locator 120 may communicate with the product locator 120 directly or indirectly, through an internal and/or external network, and may communicate via a wireless protocol.

The workflow manager 130 may provide output to a user and may, additionally or alternatively, provide output to a user via the product locator 120. The workflow manager 130 may be part of a larger workflow system or may be limited to managing workflow associated with locating and stocking product.

In one embodiment, the workflow manger 130 provides instructions for stocking tasks and the workflow progresses based on the confirmation of a task completion through the input device 125. Thus, a user of the product locator 120 provides a confirmation, through the input device 125, that a product has been stocked at the location provided by the locator 123, and the user receives instruction on the next product to stock.

An inventory processor 140 may be integrated with or separate from the product locator 120. An inventory processor 140 that is separate from the product locator 120 may communicate with the product locator 120 directly or indirectly, through an internal and/or external network, and may communicate via a wireless protocol.

The inventory processor 140 may maintain a database of products and their corresponding locations. In an embodiment, the inventory processor 140 may update a distribution center or retail store inventory based on the confirmation provided by the user through the input device 125.

The product locator 120 alone or in combination with the scanner 110 may be integrated with a mobile device 150 carried by the user. Alternatively, the mobile device and scanner may be integrated together or additionally in combination with the product locator 120.

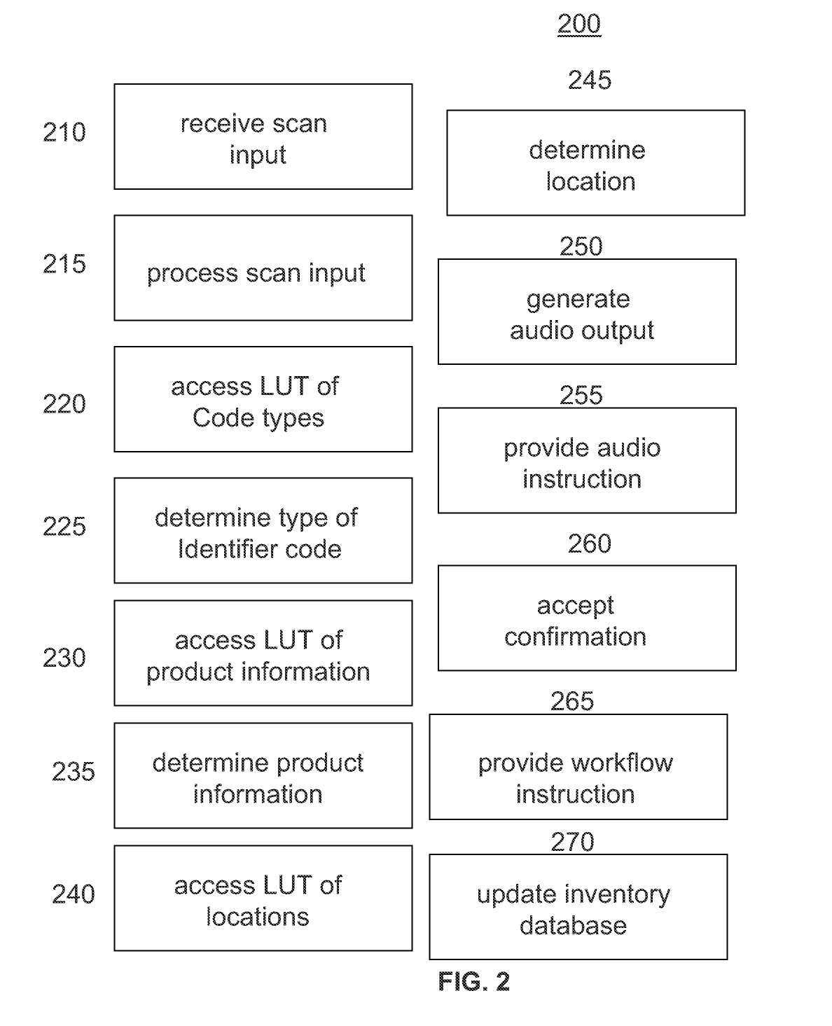

FIG. 2 is a flow chart of the stocking, workflow management, and inventory updating process, according to a non-limiting embodiment of the invention.

A scan input is received at 210 and processed as an identifier code at step 215.

Based on the identifier code output at step 215, a look-up-table is accessed at step 220. The table associates identifier codes with types. Based on a type associated with the identifier code, the type of identifier code is determined at step 225. While a look-up-table is described, the invention is not limited to this method of associating types of identifier codes with identifier codes.

Based on the type of identifier code, a look-up-table or other means may be used at step 230 to determine product information at step 235 that is associated with the type of the identifier code.

At step 240, another look-up-table or other means may be used that associates product information with locations. Based on the association, a location is determined at step 245. At step 250, an audio output is generated based on the location determined at step 245. This audio output is provided to a user at step 255.

Confirmation is accepted from the user at step 260 after the stocking task is completed. Based on that confirmation, the next task is provided as a workflow instruction at step 265. Also based on the confirmation, an inventory database is updated at step 270.

Of course, once the elements are all in place, the system contemplates variations in the order of the tasks. For example, instead of beginning with a product and being directed to a location at which to place the product, a user may be directed by the workflow manager 130 to a location at which to pick up a product. By scanning the product with the scanner 110, the user may initiate an update of the inventory to indicate that the product has been removed from the area at which it was last stored. As another example, rather than identifying the ultimate location, within a retail store, for example, where a product is to be shelved, the locator 123 may cause the output device 124 to output a temporary location. That is, when items are returned, for example, the store employee charged with returning items from the customer service desk may receive audio output directing them to a temporary holding area at each department rather than the particular shelf assigned to each product.

As noted above, one or more of the steps and devices, within the product locator 120 or the workflow manager 130 or inventory processor 140, may be implemented through a software module processed by a processor. With regard to the one or more processors that may process the one or more software modules, exemplary processors/microprocessor and storage medium(s) are listed herein and should be understood by one of ordinary skill in the pertinent art as non-limiting. Microprocessors used to perform the steps of the present invention could utilize a computer readable storage medium, such as a memory (e.g. ROM, EPROM, EEPROM, flash memory, static memory, DRAM, SDRAM, and their equivalents), but, in an alternate embodiment, could further include or exclusively include a logic device for augmenting or fully implementing the present invention. Such a logic device includes, but is not limited to, an application-specific integrated circuit (ASIC), a field programmable gate array (FPGA), a generic-array of logic (GAL), an Electronic Control Unit (ECU), and their equivalents. The microprocessors can be separate devices or a single processing mechanism.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A product locator, comprising:
a reading device to read an identifier code of a product presented by a user;
a code determination module including a processor to determine a type of the identifier code;
a decoder to determine product information based on the type of the identifier code;
a locator to determine a location of the product based on the product information; and
an audio output device to provide an audio output of the location in which the product is to be placed.

2. The product locator according to claim 1, wherein the reading device is an interrogator of a radio frequency identification (RFID) tag.

3. The product locator according to claim 1, wherein the reading device is a product code reader.

4. The product locator according to claim 3, wherein the identifier code is a vendor case label code.

5. The product locator according to claim 3, wherein the identifier code is a product label code.

6. The product locator according to claim 1, further comprising:
an input device to receive confirmation of placement of the product at the location.

7. The product locator according to claim 6, wherein the input device is configured to receive audio input.

8. The product locator according to claim 6, further comprising:
a workflow management module processed by a processor, coupled to the audio output device, and configured to provide audio output of a next task when the confirmation of the placement of the product is received.

9. The product locator according to claim 6, further comprising:
an inventory update module processed by a processor and configured to update an inventory database based on the audio input confirming the placement of the product.

10. A method of providing stocking instructions for a product, the method comprising:
receiving input of an identifier code associated with the product;
determining, by a processor, a type of the identifier code;
decoding, based on the type of the identifier code, product information of the product;
determining, based on the product information, a location of the product; and
providing, through audio output, the location of the product.

11. The method according to claim 10, further comprising:
receiving a confirmation that stocking of the product at the location is complete.

12. The method according to claim 11, wherein the receiving the confirmation includes receiving an audio input.

13. The method according to claim 11, further comprising:
providing a next task based on the receiving of the confirmation.

14. The method according to claim 11, further comprising:
updating an inventory database based on the receiving of the confirmation.

15. A system of managing product, comprising:
a workflow manager configured to assign a task to stock the product,
a product locator configured to provide a voice output of a location at which to stock the product, and
an inventory processor configured to update an inventory database based on a confirmation that the product was stocked at the location.

16. The system according to claim 15, wherein the product locator comprises:
means for reading an identifier code of the product;
means for determining a type of the identifier code;
means for determining product information based on the type of the identifier code;
means for determining the location at which to stock the product based on the product information; and
means for outputting the location.
